(19) United States
(12) Patent Application Publication
(10) Pub. No.: US 2006/0087838 A1
(43) Pub. Date: Apr. 27, 2006

(54) Light diffusion bar

(76) Inventor: Zdenko Grajcar, Crystal, MN (US)

Correspondence Address: Angenehm Law Firm. Ltd., P.O. Box 48755, Coon Rapids, MN, 55448-0755, US

(21) Appl. No.: 10/972,489

(22) Filed: Oct. 25, 2004

(51) Int. Cl. B60Q 1/26

(52) U.S. Cl. 362/227

(57) ABSTRACT

A light bar including a light strip comprising a series of light emitting diode chips mounted on a base; a plurality first diffusers each disposed over and secured about one light emitting diode chip; a tube having a first lumen and a second lumen, the first lumen and second lumen being out of axial alignment, the first lumen being defined at least in part by a second diffuser, the second lumen being defined at least in part by a third diffuser, the tube being circular in cross section, the light strip disposed in the first lumen; and depressible end caps joined to each end of the tube, the end cap being positioned adjacent a wire for communicating electrical current between adjacent light strips in adjacent tubes, the end caps being positionable against a surface and being sufficiently depressible to allow for expansion and contraction of the tube without avoiding the contact between the end cap and the surface.

### FIELD OF THE INVENTION

This invention relates to border neon tube lights and more particularly to simulated border neon tube lights.

### BACKGROUND OF THE INVENTION

Border neon tube lights are widely used today. Such lights line most downtown streets and business districts. Recently simulated border neon tube lights have been developed in recognition of the short comings and disadvantages of border neon tube. The recognized short comings of border neon tube lights have included the following: they are fragile, require high voltage, are labor intensive, and are energy consuming. While there have been simulated border neon tubes suggested, such simulated border neon lights have not been completely satisfactory.

One problem with the simulated border neon tube lights is that the light does not radiate in a 360° manner as is provided by neon tube. Simulated neon tubes typically include a light source and two diffusers which generally are not capable of providing light in a 360° arrangement around the light strip. Moreover, many of the light strips are multi-piece and fail to allow light to be directed to the wall behind the light strip, due to the additional pieces. These systems are large and bulky. The lack of adequate diffusion creates “hot spots”, e.g. points along the light strips where the light is brighter than adjacent points. To compensate, the light strips are made larger, making them less bendable.

Commonly, the lights used are LED lights, which are a form of a spot light. That is, the majority of the light rays are directed in a particular direction and the intensity wanes as one moves further away from the prime direction. This is partially compensated for by providing many more LEDs packed closely together such that the rays from neighboring LEDs overlap. This somewhat smoothes the intensity and avoids hot spots. To further distribute the light rays larger tubes encapsulate the LEDs with the tubes acting as diffusers. Instead of providing area lighting, such as that found in neon tube lights, this type of system is chained spot lights, providing over-strong intensity down a front surface of the tube with diminishing intensity as one considers the side of the tube and little to no lighting behind the tube. Examples of these simulated neon tube lights are found in the prior art.

U.S. Pat. No. 6,361,186 (Slayden) discloses a light bar with a circular cross section. Slayden has two lumens and linear diodes. Slayden does not disclose the whole of the light bar being circular in cross section. Slayden does not disclose the bar being sufficiently flexible to bend around corners of a building or being sized and configured to connect to existing neon tube holders. Slayden does not disclose the bar having depressible end caps that allow for expansion and contraction of the light bar while remaining in contact with adjacent light bar.

U.S. Pat. No. 5,934,792 (Camarota) discloses a light bar having a duel concentric lumen light flexible system, however such lumens are in axial alignment. Camarota uses attachment flanges secured such as by tacks, staples, nails, and screws. Camarota has a flexible system, is not shape retaining. Camarota does not disclose the bar being sized and configured to connect to existing neon tube holders. Camarota does not disclose the bar having depressible end caps that allow for expansion and contraction of the light bar while remaining in contact with adjacent light bar.

U.S. Pat. No. 6,394,623 (Tsui) discloses a light bar having a two concentric lumen light bar. Tsui is a rope light. Tsui has a flexible system and is not shape retaining. Tsui does not disclose the bar being sized and configured to connect to existing neon tube holders nor multiple concentric lumens. Tsui does not disclose the bar having depressible end caps that allow for expansion and contraction of the light bar while remaining in contact with adjacent light bar.

What is needed is a simulated neon lighting tube, using energy efficient LEDs and a spherical cap disposed about the LED, altering its lighting properties from a spot light to an area light. Desirably, the tube may be made of smaller diameter and remain flexible to bend around corners.

### SUMMARY OF THE PRESENT INVENTION

The present invention is a light bar having a light strip with light emitting diodes mounted on a base. The light bar has at least two lumens and three diffusers. The light bar is circular in cross section. The light bar is sufficiently shape retaining. Upon heating, is sufficiently flexible to shape i.e. to form arcs or bend around corners of a building. The light bar, upon cooling is again shape retaining. The light bar may be principally constructed of polymer, preferably polycarbonate. The light bar is sized and configured to connect to existing neon tube holders. The light bar has depressible end caps that allow for expansion and contraction of the light bar while remaining in contact with adjacent light bars. An electrical connector extends through adjacent caps to communicate electricity between adjacent light bars.

Advantageously, the present invention includes three diffusers, providing a 360° presentation of light around the light bar.

Also advantageously, the present invention has the tube formed of a monolithic, e.g. homogenous, piece of material to allow light to radiate more completely around the light bar.

As still another advantage, the light bar has three diffusers, providing more thorough diffusion and allowing the light bar to be made with a smaller diameter.

A further advantage is that the light bar has a smaller diameter, thus providing a smaller bend radius.

Yet a further advantage is that the smaller diameter light bar, the light bar can be mounted to existing neon tube holders.

These and other advantages will become more clear from reading the detailed description below with reference to the associated drawings.

### IN THE FIGURES

FIG. 1 is perspective view of a plurality of light bars of present invention in use as part of a design;

FIG. 2 is a close up perspective view of the light bar of present invention;

FIG. 3 is a cross sectional taken along the line III-III in FIG. 2;

FIG. 4 is a view of present invention as a portion of the light strip;

FIG. 5 is a perspective view showing connection of two light bars to each other and connection of the light bars to neon tube holders;

FIG. 6 is a partially exploded view of the end of a light bar of the present invention;

FIG. 7 is an end view of the light bar joined to neon tube holders;

FIG. 8 is side view of the light bar demonstrating the bend radius as discussed herein;

FIG. 9 is a schematic view showing light rays emitting out of an encapsulated LED, demonstrating reflection and refraction as discussed herein;

FIG. 10 is a top view of an encapsulated LED; and

FIG. 11 is a perspective view showing an insert, securing wires.

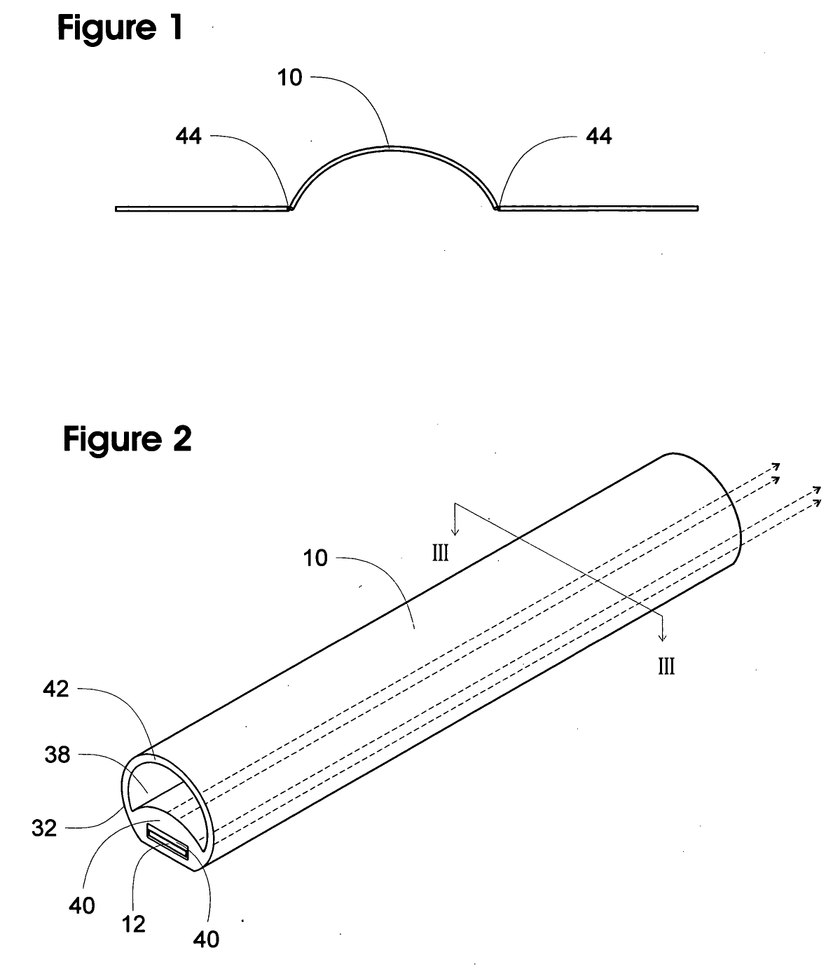

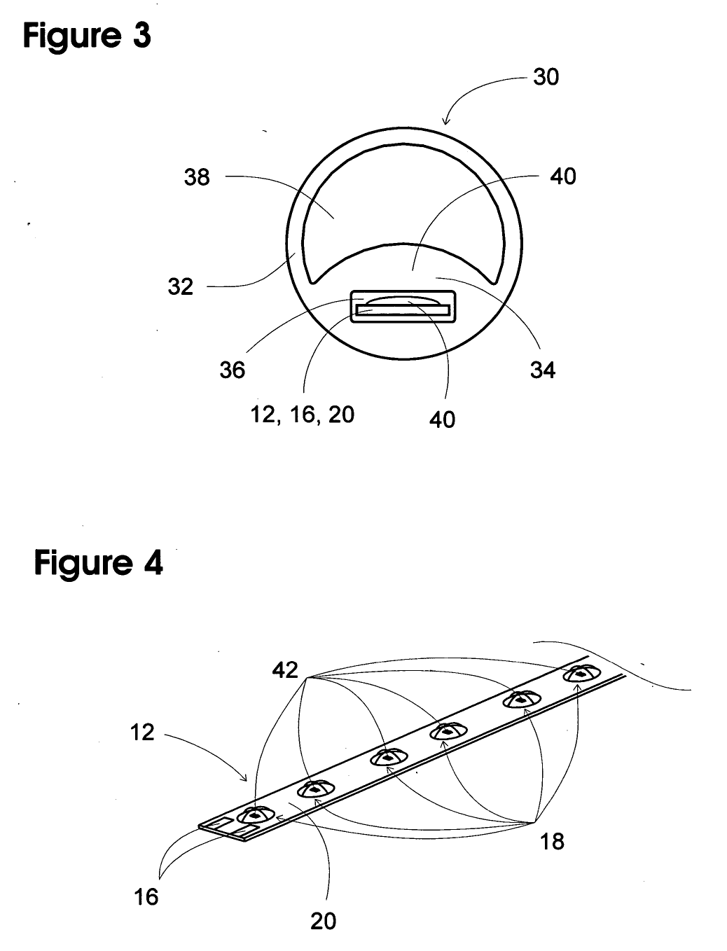

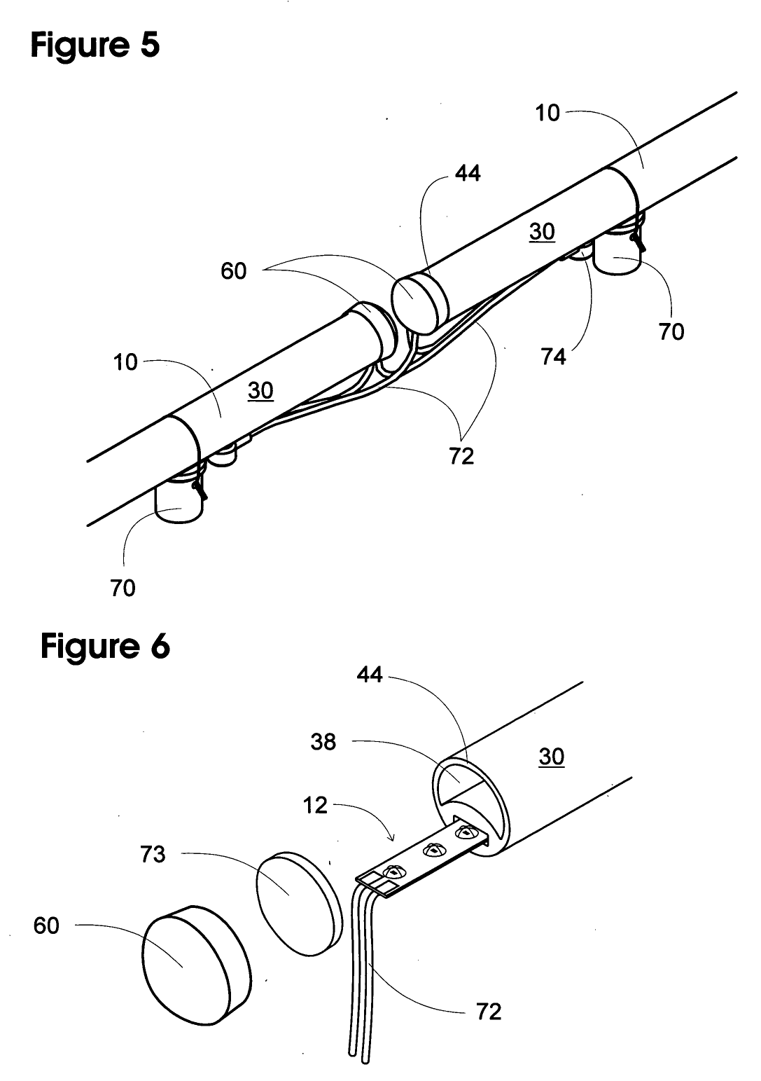

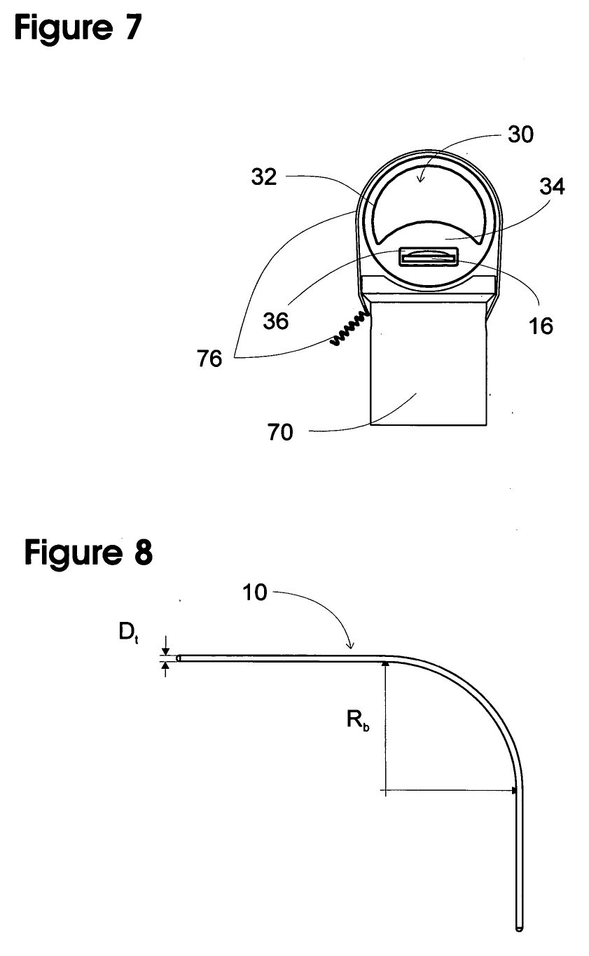

### DETAILED DISCLOSURE OF PRESENT INVENTION

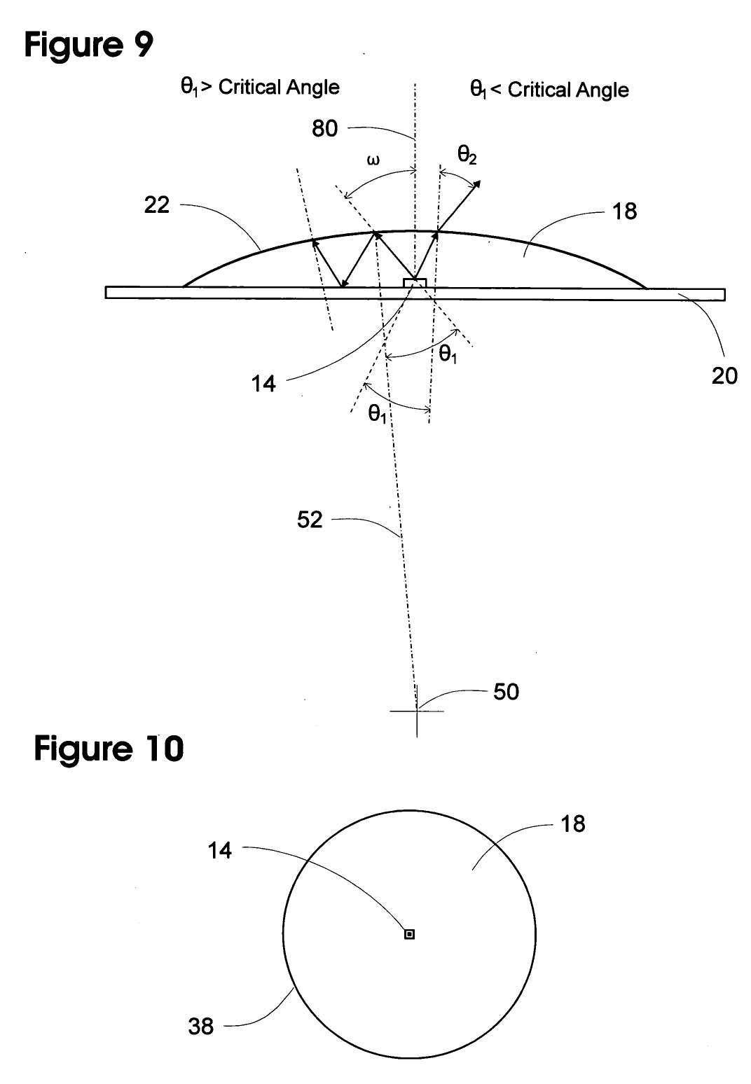

The terms have definitions as used herein the following meanings:
Bend Definitions
Bend Radius—the forward distance required for a tube to make a 90-degree turn. In practicality, bend radius is an indication of how much bending a tube can take without significantly damaging the structure of the tube.
Bend Factor—a multiple of the outside tube diameter. In formulation, R_{b}=K·Dₜ as shown in FIG. 8. R_{b} is the minimum bend radius, e.g. the radius when bent to the point that further bending will cause damage. Dₜ is the diameter of the tube. K is the bend factor. Of the preferred design, the minimum bend radius is twelve inches and the bend factor is 15.
Minimum Bend Radius—See Bend factor.
Light Transmission and Reflection Definitions
Light Reflection—optical radiation returned by a surface or a medium without significant change of frequency of it monochromatic components.
Regular or Specular Reflection—optical reflection in accordance with the laws of geometrical optics without significant diffusion.
Light Transmission—the passage of optical radiation through a medium without significant change of frequency of its monochromatic components.
Regular Light Transmission (Direct Transmittance)—process by which incident light is transmitted through a material in a straight-through manner without significant diffusion in accordance with the laws of geometrical optics.
Diffuse light transmission (Diffuse transmittance)—process by which incident light, while being transmitted through an object, is redirected or scattered over a range of different angles. There is no regular transmission involved. Diffuse Transmittance is a combination of Haze and Clarity, both a measure of the degree of scattering.
Mixed Transmission—is partially regular and partially diffuse transmission.
Light Diffuser—A light permeable mass that provides diffraction or refraction. A device to alter the spatial distribution of light depending essentially on the phenomenon of diffuse light transmission.
Spherical cap—the region of a sphere which lies above (or below) a given plane. If the plane passes through the center of the sphere, the cap is called a hemisphere.
Haze—measurement of wide-angle scattering of light, causing a loss of contrast and milkiness. Haze is measured as the percentage of transmitted light which when passing through a specimen, deviates from the incident beam by forward scattering.
Clarity—measure of narrow-angle scattering of light, causes the detail of an object to be compromised when viewing it through the translucent material.
Light Refraction—retardation (redirection) of a light ray passing through a boundary between two dissimilar media. A ray obeys Snell's law when striking a surface and refracting through a surface.
Snell's law—Mathematically expressed as n₁ sin Θ₁=n₂ sin Θ₂, where n₁ is the index of refraction of the material the incident ray is traveling through, n₂ is the index of refraction of the material the refracted ray travels through, Θ₁ is the angle of incidence, and Θ₂ is the angle measured between the ray and a line normal to the surface, intersecting the surface at the same point as the ray.
Critical angle—is the angle under which a light ray is neither refracted nor reflected (in the common usage of the term reflected). Critical angle is also known as total internal reflection. Mathematically, according to Snell's law, the critical angle is where n₁/n₂>1. The relationship between the critical angle and indexes of refraction is defined by sin Θ_{crt}=n₂/n₁ or Θ_{crt}=sin⁻¹ (n₂/n₁). If Θ₁>Θ_{crt}, then the light is reflected and if Θ₁<Θ_{crt} the ray is refracted. See FIG. 9.
Light Sources
Point Light Source—light source which emits the rays radially diverged from the source. A point light source is a reasonable representation of a local light source such as an incandescent light bulb.
Spot Light Source—similar to a point light source except that the light intensity diminishes directionally moving away from a peak direction. A good example of a spot light source is a flashlight or an LED.
Directional (or Distant Light Source)—light source where all of the rays have a common direction, and no point of origin. It is as if the light source was infinitely far away from the surface that it is illuminating. A good example of a directional light source is the Sun as it is experienced on Earth.
Area Light Source—light source which occupies a 2-D area (usually a polygon or a disk), Area light source generates soft shadows. A fluorescent tube with a plastic diffuser and a white PC monitor screen are reasonable examples of an area light source.
Ambient Light Source—a light source with no spatial or directional characteristics. Essentially, this type of light source is an imaginary one because light beams are reflected indirectly from surrounding objects. Ambient light source does not generate shadows.

The present invention is a light bar 10, which may include a light strip 12, a tube 30 and end caps 60. Such components cooperate to provide a light tube similar in light presentation to neon tube lighting with several advantages exceeding that of traditional neon tube lighting. The light bar 10 is sized and configured to connect to existing neon tube holders 70. A wire connector 72 may join adjacent light bars 10 through the end caps 60, providing electrical continuity between the diodes 14 of one light bar 10 with the diodes 14 of the adjacent light bar 10. The light bar 10, upon light heating, is sufficiently flexible to create arcs or waves. In practice, such heating may be provided by outdoor summertime temperatures. At summertime ambient temperatures, the light bar 10 has a bend radius, R_{b}=k·Dₜ, of 24 inches where k is the bend factor and for the preferred material, polycarbonate, bend factor is 30 at room temperature. Dₜ is the outer diameter of the light bar 10 and R_{b} is the bend radius. Additional heating lowers the bend factor and thus the light bar may easily be formed into right angle corners (90 degree) or wave shaped designs. The light bar 10 has a lowest bend factor of 6 at a temperature just below the melting temperature of the material. Each component will be discussed in serial fashion.

The light strip 12 may include diode chips 14 mounted on a base 20. The light emitting diode chips 14 may be arranged linearly along the base 20 and electrically connected in a manner known in the field of diodes through the base 20. Preferably, the LED chips 14 may be placed on a white (or other reflective) surface of the base 20 and electrically connected with copper conductor traces through gold wire bond. Terminal ends 16 of the base 20 may be used to conduct electrical current from one light strip 12 to an adjacent light strip 12 via a wire connector 72.

A first diffuser 18 may interact with the diode chips 14 to disperse the light rays. Preferably, a plurality first diffusers 18 are each disposed over and secured about one light emitting diode chip 14. The first diffuser 18 may be an epoxy drop. The epoxy drop may join to the base 20, contacting and encapsulating a diode 14. Other optically clear polymers, such as silicon, may be used, perhaps in a cap-type fashion, to form the first diffuser(s) 18. The size of the first diffuser 18 may be carefully controlled for maximum performance.

Light rays passing through the junction of two dissimilar media will change the direction (refraction) obeying Snell's Law. With the preferred embodiment, light rays from the LED chip 14 passes through the junction 22 of optically clear epoxy or other material forming the first diffuser 18 and air. In general, refraction index, n₁, of the preferred material, epoxy, is between 1.5 and 1.6 and refraction index, n₂, of the air is close to 1 (1.000 for vacuum). According to Snell's Law sin Θ₂=1.55 sin Θ₁, where Θ₁ is the angle between a perpendicular (surface normal) to the junction surface and the direction of the direct ray and Θ₂ is the angle between a perpendicular to the junction surface and the direction of the refracted ray. In the preferred embodiment, perpendicular to the surface of the first diffuser 18 is concurrent with the sphere radius. When angle of incidence Θ₁ becomes the critical angle, the light ray will reflect from the junction instead of refract and redirection of the light ray will obey the law of reflection. We can calculate the critical angle from the equation sin Θ_{crt}=sin⁻¹ (n₂/n₁)=sin⁻¹ (1.0/n₁ ), since n₂=1.0 for air. This phenomena is called Total Internal Reflection.

Spatial light energy distribution of a standard LED chip 14 without external epoxy encapsulation 18 shows that about 40-60% of the light energy is emitted in 45 spherical degrees from perpendicular to the LED chip 14 or main axis thereof. In the preferred embodiment, the LED 14 is encapsulated with epoxy, first diffuser 18. The first diffuser 18 may be approximately 5.5 to 6.5 mm in diameter and height (sagitta) of approximately 0.75 mm for epoxy with a refraction index of 1.54. Other sizes and materials create other calculable results as described herein.

Any ray emitted from the LED chip 14 under lower than critical angle (positioned in the center of the first diffuser 18, where hot spots emanate without the encapsulation, will pass through the junction of epoxy or other material and air and will be refracted in accordance with Snell's Law. By way of hypothetical, if the diameter of the first diffuser is 6.5 mm and the sagitta is 0.75 mm, and refraction index of epoxy is 1.54 than any ray emitted under an angle higher than the critical angle, approximately 40.5 degrees from the main axis of the LED chip 14 will strike the junction surface under higher than critical angle. (Critical angle in this case is Θ_{crt}=sin⁻¹ (n₂/n₁)=sin⁻¹ (1.0/n₁)=sin⁻¹ (1.0/1.54)=40.5 degrees.) All such rays will be reflected from the junction, obeying the laws of reflection towards the white or other reflective surface of the base 20 and then reflected back toward the junction. If a ray strikes the junction surface at an angle lower than the critical angle then it will be refracted. FIG. 9 illustrates this concept in graphic form with the LED chip 14 with first diffuser 18 disposed on the base 20, the center 50 of the sphere (defined by the first diffuser 18) and radius 52 perpendicular to the surface of the first diffuser 18 at the junction surface where the light ray impacts.

The preferred embodiment preferably refracts only about 50% of the rays the first time the rays strike the junction surface with the remainder being reflected, total internal and otherwise. The reflected rays, other than those that are totally internally reflected, will exit the encapsulation at another point. In this manner the entire first diffusor 18 emits light on its entire surface, which is preferably at least two hundred and twenty-five times the surface area of the LED chip, e.x. (from 0.09 mm² compared to 20 mm²). Therefore, the first diffuser 18 being disposed adjacent the LED chip 14 with a reflective base 20, causes the encapsulated LED chip to approximate an area light source, whereas an unencapsulated LED chip 14 acts as a spot light source. The present invention therefore, more closely imitates neon lighting, eliminating hot spots on the tube 30.

The tube 30 may have an outer wall 32, an interior wall 34, and ends 44. The outer diameter may be under one and a half inches and preferably under one inch. The tube 30 may slidably engage the light strip 12. The outer wall 32 may cooperate with the interior wall 34 to define the first lumen 36 and second lumen 38. Desirably, the outer wall 32 and interior wall 34 are monolithic, e.g., homogenous. That is, both walls 32 and 34 are of a continuous piece of material, preferably, polycarbonate. The tube 30 may be generally circular in cross section.

The first lumen 36 is a channel-like opening positioned between the outer wall 32 and the interior wall 34. The first lumen 36 is sized and configured such that the base 20 may be loosely disposed in the first lumen 36 of the tube 30, extending between the ends 44. Light from the diodes 14 disposed on the base 20 passes through the interior wall 34 with the interior wall 34 being a second diffuser 40. The second light diffuser 40 may be at least a portion of the interior wall 34. Thus, the first lumen 36 may be defined at least in part by a second diffuser 40 and the outer wall 32.

The second lumen 38 is a channel-like opening defined between the outer wall 32 and the interior wall 34. The second lumen 38 is adjacent a side of the interior wall 34 opposite the first lumen 36. The second lumen 38 is of a size to allow for adequate diffusion of the light such that the third light diffuser 42 avoids displaying hot spots. Hot spots are not visible to the naked eye with the outer diameter of the light bar 10 being 0.75 inches or larger with walls perhaps 0.1 inches and thicker. The portion of the outer wall 32 adjacent the second lumen 38 is sized and configured to be a third light diffuser 42. It should therefore be understood that the second lumen is defined between the second and third diffusers 40, 42. The second and third diffusers 40, 42 preferably are in an alignment such that a ray of light from a light emitting diode 14 passes through the first diffuser 18, the second diffuser 40 and the third diffuser 42 before leaving the tube 30.

The first lumen 36 may have a central axis 37 and the second lumen 38 has a central axis 39. The central axis 37 of the first lumen 36 and the axis 39 of the second lumen 38 are out of axial alignment. The axis 39 of the second lumen 38 preferably is offset and parallel to the central axis 37 of the first lumen 36.

Depressible end caps 60 may be joined to each end 44 of the tube 30. The end caps 60 can provide a port 62 for communicating wires 72 with connectors 74 and thus electrical current between the terminal ends 16 of adjacent light strips 12 in adjacent tubes 30. Alternatively, the wire may be held with insert 73 constructed and assembled as shown in FIG. 11. The end caps 60 preferably are positioned against a surface, such as an adjacent end cap 60 of an adjacent light bar 10, and are sufficiently depressible to allow for expansion and contraction caused by changes in ambient temperature of the tube(s) 30 without avoiding the contact between the ends 44 of two neighboring tubes 30. The end caps 60 are desirably translucent and although not positioned to act as a diffuser for presentation of the light, the caps 60 being translucent and rounded do function as a fourth diffuser.

In operation, the base 20 is inserted into the first lumen 36 of the tube 30. Connector wire 72, extending through the port 62 of the end cap 60 or insert 73 joins to the base 20, perhaps at a terminal end 16 thereof. The connector wires 72 electrically connected through electrical connectors 74 supply power to light the diodes 14. The light from the diodes 14 pass through the first diffuser 18, the second diffuser 40, the second lumen 38 and the third diffuser 42. In this manner, light from the diodes is evenly spread, avoiding hot spots and simulates neon lighting with light extending behind the light bar 10 as well as in front of the light bar 10, e.g. approximately 360°. The wire connector 74 can be used to connect a plurality of light bars 10.

Although specific embodiments have been disclosed herein, it should be recognized that many more are possible within scope of hereinafter appended claims. For example, various other materials and shapes may be used.

What is claimed is:

1. A light bar comprising:
a light strip comprising a series of light emitting diodes mounted on a base;
a plurality first diffusers each disposed over and attached to one light emitting diode;
a tube having a first lumen and a second lumen, the first lumen and second lumen being out of axial alignment, the first lumen being defined at least in part by a second diffuser, the second lumen being defined at least in part by a third diffuser, the tube being circular in cross section, the light strip disposed in the first lumen; and
depressible end caps joined to each end of the tube, the end cap positioned adjacent wires communicating electrical current between adjacent light strips in adjacent tubes, the end caps being positionable against a surface and being sufficiently depressible to allow for expansion and contraction through outdoor temperature variations of the tube without avoiding the contact between the end cap and the surface.

2. The light bar of claim 1 wherein the series light emitting diodes are arranged linearly.

3. The device of claim 1 wherein the first diffuser is a epoxy drop.

4. The device of claim 1 wherein the light bar upon being heated is sufficiently flexible to bend around to form a design.

5. The device of claim 4 wherein the light bar has a bend radius of 24 inches and bend factor of 30 at room temperature and bend radius of 4.5 inches and bend factor of 6 at a temperature not exceeding the melting temperature of the material.

6. The device of claim 4 wherein the light emitting diodes in conjunction with the first diffuser approximate an area light source.

7. The device of claim 4 wherein at least 50% of light rays from the light emitting diode are reflected before passing through the first diffuser.

8. The device of claim 1 wherein the light bar is sized and configured to connect to existing neon tube holders.

9. The light bar of claim 1 wherein the first lumen is defined between the second and third diffusers.

10. A light bar comprising:
a light strip comprising a series of light emitting diodes chip mounted on a base;
a plurality first diffusers each disposed about and joined directly to one light emitting diode chip; and
a tube slidably engaging the light strip.

11. The device of claim 10 wherein the light emitting diode chips are arranged linearly.

12. The device of claim 10 wherein the base is disposed in a lumen defined in the tube.

13. The device of claim 10 wherein the base is joined to the first diffuser.

14. The light bar of claim 10 further comprising an adjacent light bar and a wire connector providing electrical continuity between the diodes of one light bar with the diodes of the adjacent light bar.

15. A simulated neon tube light comprising:
a light strip comprising a series of light emitting diode chips mounted on a base;
at least one first diffuser operably joined to one of the light emitting diode chips;
a tube having an outer wall;
an interior wall cooperating with the outer wall to define a first lumen, the first lumen having a central axis, the interior wall being a second light diffuser, the light strip being disposed in the first lumen; and
a second lumen defined at least in part by the outer wall, the second lumen having a central axis offset and parallel to the central axis of the first lumen, the outer wall adjacent the second lumen being a third light diffuser.

16. The device of claim 15 further comprising a plurality of first diffusers wherein the first diffusers are epoxy drops disposed on each diode.

17. The device of claim 15 wherein the outer wall and interior wall are monolithic.

18. The device of claim 15 wherein each first diffuser is secured to one light emitting diode chip.

19. The device of claim 15 further comprising a deformable end cap disposed at each end of the tube.

20. The device of claim 19 wherein the end caps are depressible allowing for expansion and contraction of the light bar while remaining in contact with adjacent light bars.
